(19) United States
(12) Patent Application Publication
(10) Pub. No.: US 2008/0112335 A1
(43) Pub. Date: May 15, 2008

(54) METHOD AND DEVICE FOR ADAPTING LABEL-SWITCHED PATHS IN PACKET NETWORKS

(75) Inventors: Jochen Grimminger, Munchen (DE); Andreas Kirstadter, Ebersberg (DE)

Correspondence Address: BELL, BOYD & LLOYD, LLP, P.O. BOX 1135, CHICAGO, IL, 60690, US

(73) Assignee: Nokia Siemens Network GmbH & Go. KG, Munchen (DE)

(21) Appl. No.: 12/018,093

(22) Filed: Jan. 22, 2008

Related U.S. Application Data
(63) Continuation of application No. 10/491,083, filed on Mar. 29, 2004, now abandoned.

(30) Foreign Application Priority Data
Jul. 5, 2005 (DE) 10 2005 031 410.4
Sep. 27, 2001 (DE) 10147748.1

(51) Int. Cl. H04L 12/28; H04L 12/56

(52) U.S. Cl. 370/254; 370/389

(57) ABSTRACT

The invention relates to a method and a device for adapting label-switched paths, in particular MPLS paths, in packet-oriented networks which comprise routers. At least some of the routers exchange information with adjacent routers, by means of a protocol, about the status of the network, in particular about load shifts, availability changes and bandwidths, in order to recognise possible bottlenecks or improvements and, in the case of adjacent bottlenecks, locally altering paths which run through said bottlenecks, by means of partial replacement paths such that said bottlenecks are by-passed and in the case of adjacent improvements, the paths which run around said improvements are altered such as to retain said improvements in the path.

### CLAIM FOR PRIORITY

This application claims priority to International Application No. PCT/DE02/03595, which was published in the German language on Apr. 10, 2003, which claims the benefit of priority to German Application No. 10147748.1 which was filed in the German language on Sep. 27, 2001.

### TECHNICAL FIELD OF THE INVENTION

The present invention relates to a method and device for adapting label-switching paths in pact networks.

### BACKGROUND OF THE INVENTION

As a result of the introduction of packet-oriented technologies such as UMTS and GPRS, it is to be expected that in future data transmission will increasingly be effected by wireless means. In doing this, it will not be possible to restrict the data transmission to simply the transmission of voice data, but other services, such as those offered on the Internet, will be increasingly used on a wireless basis. So that it is also possible to switch through the increased bandwidth of the terminal devices, the core network which is used for distributing the data must also be enhanced. In other networks too, for example the Internet, a steadily growing need for bandwidth is detectable. A large proportion of the bandwidth is lost in the routing of the data. This can be attributed to the fact that a large proportion of the decisions which concern the routing of the packets are made at a higher protocol level. In general, this is the IP level. Recently, however, increasing use has been made of label-oriented routing or switching, as appropriate. It should be noted that no distinction is made in what follows between the terms routing and switching, although there are different approaches to this in the literature. The advantage of label-oriented routing lies in the fact that the amount of data to be considered in making a decision is smaller and, because of this more limited volume of data and the use of particular classes, it is easier to reach a decision.

One of the most frequently used label-oriented methods is MPLS.

Because of its simple structure and high performance, the IETF Proposed Standard on Multiprotocol Label Switching (MPLS), [RFC 3031 and other RFCs] can also be used with advantage as a tunneling technology.

In MPLS networks, a packet travels from one router to the next. Each router makes an independent decision about the routing. That is, each router analyzes the header in the packet, and each router executes a program containing the routing algorithm. Each router selects a new route, which depends on the results of the routing algorithm. The selection of the subsequent route is thus made in two steps. The first step partitions the complete set of possible packages into a set of equivalent classes (FEC). An equivalence class generally consists of a set of IP addresses or certain IP address patterns, which are defined by masks. The second step maps each FEC onto a route. As far as the decision about routing is concerned, no distinction is made between the packets which belong to the same FEC. Different packets which belong to the same FEC cannot be distinguished.

In an MPLS network, the assignment to an FEC is made only once, namely when the packet arrives in the MPLS network. The FEC which is assigned to a packet is encoded as a short value, which is called a label. When a packet is sent on along the next route, the label is sent with it. At subsequent routers, absolutely no analysis is undertaken of the other contents of the packet. Only the label is checked. The label is used as the index to a table, from which the next route and the next label can be read. The old label is replaced by the new one and the packet is forwarded on along the next route. In an MPLS network, forwarding is controlled solely by the label. This has a range of advantages. It means that the routers only need limited capabilities. In order to replace the old label by a new label, they only need to be in a position to analyze the label and to check in a table which route is assigned to this label. Furthermore, these simple functions enable a higher throughput to be realized. Further advantages will be found in RFC 3031.

Below are defined a few principles. A label is a short, locally-significant name, which has a fixed length, by which an FEC is identified. The label serves to represent an FEC, to which the packet is assigned. For its basic use, the FEC is assigned on the basis of the destination addresses of the network layer.

In order to ensure that the routers assign the packets to the same equivalence classes, the routers must regularly exchange data from which it can be seen which packets are assigned to a label. In addition, it is important that different routers do not use the same labels if this would make unique identification of the preceding router impossible. Furthermore, it must be pointed out that up-stream and down-stream are handled differently. As a result they will not always have the same labels. In the MPLS architecture, the decision to bind a particular label to a particular equivalence class is made by the router which is down-steam in relation to this binding. The router which is down-stream then informs the router which is up-stream of this binding. This data can be transmitted, for example, as pickaback data on other packets, or by a dedicated data transmission [RFC 3031, 3035, 3036, 3037, 3038, 2205-2210, 2379, 2380, 2746, 2750, 2814, 2702].

In a further embodiment MPLS supports a hierarchy, with the processing of packets which have been given labels being independent of the level in the hierarchy. A packet which has no label can be regarded as a packet which has an empty stack. The use of the stack will be clear if one speaks of tunneling by the packets. Such a tunnel can be found in the document RFC 3031. Packets are tunneled whenever they are routed along a network path which lies between two routers, and where this network path can in turn incorporate a series of routers. For example, if an explicit path were prescribed incorporating the routers R1 to R4, and if between the routers R1 and R2 there is a path via the routers R1.1, R1.2, R1.3, then router R1 will push another label onto the stack. The routers R1.1, R1.2, R1.3 now work on this new second element. As soon as the packet arrives at router R2, the top element in the stack is popped. Problems arise when there is no label on the stack. With the normal MPLS architecture, the network address (normally the IP address) is analyzed in order to determine an equivalence class.

MPLS offers two forms of route selection. With one of these, the route is specified back at the start point. The individual routers which must be passed through are defined. This is a case of explicit routing. In the case of hop-by-hop routing, the routers are not explicitly specified, so that each router can determine by reference to its tables which should be the next router. The present invention can be operated with both possible forms of route selection.

If one considers the amount if data which is required to route the packets, that is the headers, then it will be clear that in the case of path-oriented protocols there is an enormous potential for savings. IPv6 headers cause header overheads of more than 40 bytes for a transport data volume of 60 bytes on average (IPv6 including routing header), of which correspondingly the useful data amounts to only 20 bytes (VoIP) [RFC 3031, RFC 2460]. The use of a shim header or an MPLS header from, for example MPLS, involves in either case only 4 bytes. A shim header, also an MPLS header, includes in addition to the label, which amounts to about 20 bytes, further status and administration data. Basically, it needs to provide a unique identification of the point-to-point link with its properties, e.g. Quality of Service (QoS) and, of course, the bearer's identification.

Apart from the speeding up of packet routing which results from layer 2 analysis instead of a costly layer 3 header analysis, by comparison with a longest-prefix-match the packet path can be explicitly prescribed (source routing), which forces the path to be the same for all paths. By this means, greater control can be achieved, in particular in terms of the quality of service considerations.

By the use of tunnels it is possible to avoid layer 3 routing operations and decisions between an operator's subnetworks which are in different locations (and linked by a transport network). This approach will always be important when virtual private networks are to be realized.

A further point is the avoidance of L3 routing operations and decisions between forwarding units in different locations in mobile IP architectures. (“Hierarchical Mobile IP”, see the appropriate draft under www.ietf.org on the Internet)

Because of the advantages cited, the use of label-switched paths to simplify routing in packet networks (e.g. using MPLS, Multi-Protocol Label Switching) is increasingly gaining in importance.

However, the use of label-switched paths also has some disadvantages. Due to the path being prescribed irrevocably at its start, it is not possible for MPLS, for example, to react dynamically and in a locally limited way to such current developments as shifts in load, and changes in the availability and bandwidth of network components.

To date, solutions for these cases have observed the network continuously from outside it, so that if necessary the standard MPLS signaling can be used to re-establish each path again from start to finish. In doing so, the complete paths are so reorganized that the path is then appropriate for the changed conditions and connection requirements. However, this requires the complete network, in particular the routers and the network segments which are connected to the routers, to be continuously monitored by a central unit.

This monitoring requires substantial expenditure by the network operator while it is in operation, and is responsible for a major portion of the costs.

### SUMMARY OF THE INVENTION

The present invention provides a method which makes possible optimized monitoring of the network.

Fundamentally, the approach is to permit limited and autonomous decisions by the Label Switched Routers (LSRs) in the label switched routing process.

By an extension of the signaling protocol, e.g. the LDP [RFCs 3031, 3035, 3036, 3037, 3038] or RSVP [2205-2210, 2379, 2380, 2746, 2750, 2814], the Label Switched Routers (LSRs) are given the autonomous ability to divert the paths to other neighboring nodes. The protocols cited are standard protocols, with the help of which network components exchange administrative data. However, it is also possible to make use of other non-standardized protocols. For this purpose, the individual network components, in general routers, monitor the current routing situation (in terms of load and availability) in their immediate neighborhood and, using an extended signaling protocol make comparisons between each other of this status, taking into account the path, so that if necessary they can then make appropriate local modifications to the label-switched paths.

In doing this, the routers will preferably exchange details at regular intervals about the status of the network, particularly the load displacement, and changes in the availability and bandwidths, to recognize possible bottlenecks or improvements. By the use of a periodically synchronized exchange, it is also possible to determine whether a certain router has completely failed. This exchange of data makes it possible, in the event that there are neighboring bottlenecks, to make local changes to the paths which pass through these bottlenecks, using alternate subpaths, so as to get round the bottlenecks. These alternate subpaths might be ready-prepared paths, set up in advance, to divert round particular components or segments in the event of their failure. The preparation of these paths is not particularly expensive, because they involve a restricted number of neighboring routers which are monitored. Alternate subpaths are stored for these routers or segments. It should also be pointed out that, in particular in the case of MPLS paths, the paths are manipulated in the dataflow direction. Hence, the data incidence which are administered is fairly small. In an alternative exemplary embodiment, the necessary alternate subpaths can also be generated dynamically. With this alternative approach, the alternate subpaths are preferably calculated on the basis of a routing algorithm which accesses the routing tables, whereby the routing algorithm can be passed a parameter indicating which router or network segment is/are to be considered or not considered in selecting the route. These algorithms are based on the familiar methods which are used, particularly in an IP network. If a neighboring router reports that there are problems on a particular segment, then the preceding router in the data flow will check whether it is administering paths which are routed via this network segment. An analysis of this type can generally be made using comparison operations, whereby the path is checked to determine whether it is routed via the problematic network segment. The dynamic determination of the alternate subpath depends on the nature of the change. If improvements arise in the neighborhood, which could occur for example when a load situation has ended, the paths which originally were diversions round the load situation should be selected. In one possible form of embodiment, the paths which originally were diverted are marked so that if an improvement occurs in the load situation they can then in turn be routed via their old network segment. This marking makes it easier to access possible candidates for change. For this purpose, the routing algorithms must be modified so that a route will be selected which of necessity leads via the improved network segment. In doing so, however, a weighting is applied so that paths are not unnecessarily rerouted if it is logical not to route them via this improved network segment. This weighting could, for example, be determined by a prior marking. A weighting could also be applied on the basis of a particular priority or a certain quality of service requirement. One special form of embodiment selects those paths which, in the data flow direction, go to a point immediately behind the improved network segment, but for which the improved network segment is not part of the path. In this case, a speeding-up of the data traffic can be achieved by a simple diversion of the paths via the improved network segment. In another form of embodiment, one node or router before and after the improved network segment is selected and a check is made on which paths pass through this router/node. For these paths, the alternate subpath so determined is then integrated. In another embodiment, other routers/nodes which lie in the neighborhood of the improved network segment can be considered, to determine paths which are diverted by a greater distance. For these too, it is then possible to integrate an appropriate alternate subpath.

On the other hand, if a deterioration in the transmission situation pertains, then those paths will be determined which pass through the corresponding degraded network segment, so that a route can then be dynamically found which if possible has as its destination the first assigned node or router, as applicable, after the degraded network segment in the direction of the data flow. If no such route can be found, then the next-but-one node or router after the degraded network segment, in the direction of the data flow, is chosen. On the other hand, if no success is achieved by this method, then an attempt will be made to find an alternate subpath by the use of the same procedure by the preceding nodes or routers, looking in the direction of the data flow. In doing this, the algorithms are adjusted so that the defective network segment is not considered. If no success is forthcoming in the immediate neighborhood, then the route finding procedure is terminated. In an optimized form of embodiment, simple structures are used, in particular hash structures, to preassign the paths to the neighboring routers through which they run.

Other familiar algorithms, which are not itemized here, are also conceivable.

For determining the routers which belong to a local communications set, either an automated procedure or a manual procedure can be used. With both approaches it is, of course, logical that the sets intersect with each other. In the case of a manual configuration, the neighboring routers, with which data about the load situation in the network is to be exchanged, are selected and assigned by an administrator. In the case of an automated assignment, use can be made of a metric, with the help of which the neighboring routers or nodes, as applicable, can be determined. Subject to the definition of a threshold value, those routers or nodes will be selected which lie within an area defined by the threshold. The metric could thus, for example, consider the number of nodes as the measure. In addition, the lengths of the network segments could provide an input into the calculation.

For the exchange of data, it is preferable to use familiar protocols which transport the data either pickaback on the data packets or via a separate connection, which will generally be based on TCP-IP. In general, either RSVP or LDP will be used here (see the appropriate RFCs). However, care should be taken that these protocols are applied in the immediate neighborhood. Consequently, it is advantageous to address the nodes or routers by means of dedicated addresses.

In a preferred embodiment, MPLS is used to specify the paths. When MPLS is used, there are different options for integrating alternate subpaths into existing paths. In a first embodiment, the alternate subpaths are used for tunneling. In MPLS, tunneling is achieved by arranging additional labels on the stack for the MPLS packet. A detailed example will be found above. In another exemplary embodiment, an explicit path is integrated into the path. In the case of an explicit path, the individual routers or nodes, as applicable, are itemized in a list, with the individual routers being bound to the list if they make decisions about the forwarding of the packet. Here again, detailed expositions will be found above. In the third alternative, the equivalence classes are amended and sent on to the neighboring routers. This generally results in a one-time avalanche-like process, which extends through a limited area of the network. A detailed description of this method will be found in the RFCs cited above.

In another embodiment of the present invention, there is a device, in particular a router, for controlling label-switched paths, in particular MPLS paths, in packet-oriented networks. The device implements the method in accordance with the invention. In general, these are familiar components, which are already in standard use in routers, but the functionality of which has been enhanced by an additional software module.

In a further embodiment, there could be an additional processor which can access a memory area, whereby the processor can access I/O devices via an interface, to permit an exchange of data via the router's ports.

Further, the device has analysis facilities which preferably take the form of sensors, counters or timers, to enable statistical statements to be made using their values. Another factor which the analysis facilities record is lost packets or the absence of a status feedback report from a neighboring router. With the facilities described it is directly possible to determine the status of the load displacement, and the changes in availability and bandwidth. The data thus determined is exchanged with neighboring devices, in particular routers, via an interface which can preferably be addressed via an IP address. The interface generally takes a form such that it is compatible with the nature of the network (fiber optic, copper) and such that there is an interface through which this data can be exchanged.

The status data thus transmitted is saved by each device in a special storage area. These storage areas can generally be accessed by means of fast algorithms, such as hash tables. Paths which pass through these routers are saved in relation to these items of data, which are assigned to the individual routers. In addition, paths are saved which were in the past routed through these routers but which were subsequently diverted by calling on alternate subpaths. By reference to these items of data it is now simply possible to determine the paths for which the propagation time can be improved.

In still another embodiment of the invention, the device is a microprocessor which determines the paths which are affected by a change in the network status. Thus, this determination can be made particularly rapidly if there is a unique indexing, e.g. by means of hash tables, by which it is possible to determine the paths which are affected by the change. This method will be simple to realize whenever degradations are concerned. On the other hand, if there are improvements in the network status, then it is necessary to consider all the paths which divert round this network segment. For this purpose too, a separate hash table could be set up. Alternatively, other algorithms which speed up a search or an access could be used. However, it is also conceivable that the paths which divert round a segment could be determined by checking whether there are nodes which are downstream and upstream relative to the improved segment. If this is so, then the path will pass round the improved segment, and a connection incorporating the alternate subpath through the segment could be advantageous.

In searching for alternate subpaths, use is made of familiar facilities, which implement familiar algorithms for the determination of routes. There is a host of familiar routing algorithms in the literature. Insofar as is necessary, these algorithms will be enhanced to take into account parameters which provide information about segments which should either be included in the path or should be excluded from it.

For finding alternate subpaths, the most widespread algorithms use routing tables which are held in a storage area. If such data is missing, then routing queries are sent to neighboring routers via appropriate I/O interfaces, to refresh the tables.

In determining the alternate subpath, the primary destination is specified as being the nearest reachable node which follows the network segment which is affected by a performance change.

In a preferred embodiment, the hardware components which are already present are controlled by appropriately adapted software in order to achieve the performance indicated.

### BRIEF DESCRIPTION OF THE DRAWINGS

The description which follows explains the FIGURE. The FIGURE shows:

FIG. 1 shows a network including several routers, in which a path which was originally routed via a node R5 is diverted along another path.

### DETAILED DESCRIPTION OF THE INVENTION

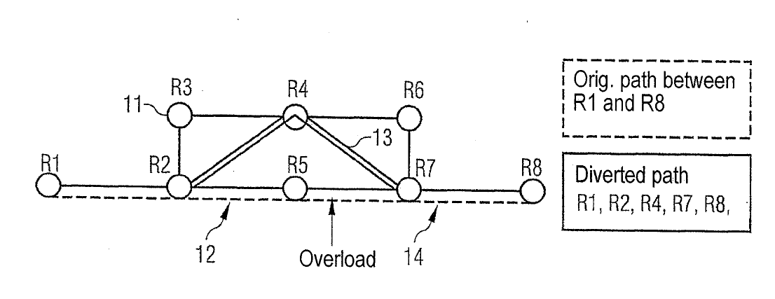

FIG. 1 shows a network which consists of routers 11 R1 to R8, which are linked by network segments which are represented by lines. The original route 12, which is shown dashed, leads from R1 via R2, R5 R7 as far as R8. Due to an overload 14 between routers R5 and R7, a message is sent to the router R2 that the segment does not offer sufficient performance. This transmission originated from the router R5. The router R2 now selects the shortest diversion 13 to get round this segment. In the present case, this shortest diversion is via the alternate subpath R2, R4, R7. This alternate subpath is incorporated into the original path, so that the path now reads R1, R2, R4, R7, R8. It should be pointed out that other considerations could equally have been employed to form an alternate subpath. Thus, a diversion via the nodes R5, R4, R7 could have been effected. This will always depend on the heuristic used, and on the current load situation.

1. A method for modifying label switched paths in packet-oriented networks, comprising:
identifying bottlenecks or improvements using routers wherein at least one of the routers use a protocol to exchange data about a status of the network and changes in availability and bandwidth and
if there are neighboring bottlenecks, modifications are made to paths which lead through the bottlenecks, using alternate subpaths, to divert around the bottlenecks and/or if there are neighboring improvements, paths which divert around the improvements are modified to incorporate the improvements into the path.

2. The method in accordance with claim 1, wherein a set of neighboring routers is assigned manually or is arranged to be at a certain distance.

3. The method in accordance with claim 1, wherein exchange of data between the routers is effected either pickaback on regular data traffic or by a separate connection.

4. The method in accordance with claim 3, wherein RSVP or LDP is used.

5. The method in accordance with claim 1, wherein the routers assign to each path which they administer the neighboring routers which lie on the paths, which facilitates modification of the paths if a router or a neighboring network segment which emanates from a router is subject to a performance fluctuation.

6. The method in accordance with claim 1, wherein ready-prepared alternate subpaths are administered in the event of a deterioration in performance of a neighboring router or a neighboring network segment, the subpaths configured to effect a diversion around the neighboring router or the neighboring network segment by integration of the alternate subpath into an existing path, or
ready-prepared alternate subpaths are administered in the event of an improvement in the performance of the neighboring router or the neighboring network segment, the subpaths configured to effect inclusion of the router or network segment in the path by integration of the alternate subpath into an existing path.

7. The method in accordance with claim 1, wherein if there is a performance fluctuation in neighboring routers or network segments, a dynamic alternate subpath is generated, such that in an event of an improvement in performance of one of the neighboring routers or a neighboring network segments an alternate subpath is formed such that the router or the network segment lies within the path after the alternate subpath has been integrated, and in an event of a deterioration in the performance of the neighboring router or the neighboring network segment, an alternate subpath is formed such that the router or the network segment lies outside the path after the alternate subpath has been integrated.

8. The method in accordance with claim 1, wherein the alternate subpath is calculated based on a route algorithm which accesses routing tables, wherein the routers or network segments which are considered in selecting the route can be passed to the route algorithm as a parameter.

9. The method in accordance with claim 1, wherein MPLS is used as a protocol for specifying the paths, wherein the alternate subpaths are realized by tunneling, by insertion of an explicit path, or by changing equivalence classes and then propagating the equivalence classes.

10. A device for controlling label-switched paths in packet-oriented networks, comprising:
routers, where at least some of the routers use a protocol to exchange data about a status of the network and changes in availability and bandwidth, to identify possible bottlenecks or improvements, so that if neighboring bottlenecks occur, modifications are made to paths which lead through the bottlenecks using alternate subpaths, to divert around the bottlenecks and/or if neighboring improvements occur, paths which divert around the improvements are modified to incorporate the improvements into the path.

11. The device in accordance with claim 10, further comprising analysis facilities which perform a check on a status of the neighboring network and the changes in the availability and bandwidths, and is an interface via which items of data are exchanged.

12. The device in accordance with claim 11, wherein the network status for other routers and for networks which are not immediately neighboring is stored in a storage area to use these items of data to determine the paths for which propagation times can be improved.

13. The device in accordance with claim 10, further comprising facilities which compare the paths and stored network statuses with each other to determine the paths which are affected by a change in the network status in the event of neighboring bottlenecks, to determine or create an alternate subpath which diverts around the bottleneck, and in the event of a neighboring improvement to determine or create an alternate subpath which passes through the improvement, wherein the alternate subpath which is determined is integrated into the path by modification of the router functionality.

14. The device in accordance with claim 10, wherein a selection is made are so that a shortest possible alternate subpath is determined.

15. The device in accordance with claim 14, wherein the alternate subpaths are determined by using routing tables which are held in a storage area, or by sending routing queries to neighboring routers, wherein a destination selected for the path is the network segment or the router which is located in a data flow direction immediately after the network segment which is affected by a performance change.

16. (canceled)
